(19) United States
(12) Patent Application Publication
(10) Pub. No.: US 2013/0068081 A1
(43) Pub. Date: Mar. 21, 2013

(54) TOOL FOR RE-CUTTING WIPER BLADES

(71) Applicants: Mario Kronberg, Rastatt (DE); Adnan Alibegovic, Beinheim (FR)

(72) Inventors: Mario Kronberg, Rastatt (DE); Adnan Alibegovic, Beinheim (FR)

(21) Appl. No.: 13/701,839

(22) PCT Filed: Jun. 3, 2011
(86) PCT No.: PCT/EP2011/002733

§ 371 Date: Dec. 4, 2012

(30) Foreign Application Priority Data
Jun. 11, 2010 (DE) 202010007855.5

(51) Int. Cl. B26D 3/28

(52) U.S. Cl. CPC B26D 3/28
USPC 83/870

(57) ABSTRACT

A tool for re-cutting worn wiper blades (3) for window wipers, the wiper blades (3) having an increasing cross section from their edge on the window side and having at least one longitudinal groove (3a) within the blade on both sides, and these longitudinal grooves (3a) corresponding to at least one guiding strip (2a) of a guiding slot (2) of the tool in such a way that the wiper blade (3) can be drawn in the longitudinal direction through the guiding slot (2) of the tool at a defined height, a blade (4) being arranged in the guiding slot (2) and slicing off the worn edge (6) of the wiper blade (3) as it is drawn through the tool. An important aspect here is that the tool (1) has at least two guiding slots (2) and that the distance between the guiding strips (2a) thereof on the one hand and the assigned blade (4) on the other hand is variable.

### BACKGROUND

The invention relates to a tool for re-cutting abraded wiper blades for window wipers, wherein the wiper blades have an increasing cross section from the border thereof on the window side and at least one longitudinal groove on both sides therein, and said longitudinal grooves correspond to guide strips, preferably on both sides, of a guide slot of the tool in such a manner that the wiper blade is drawable in the longitudinal direction through the guide slot of the tool at a defined height, and a blade which slices off the worn border of the wiper blade as the latter is drawn through the tool is arranged in the guide slot.

New wiper blades have sharp edges on the border thereof facing the window over the course of the use time, these edges are abraded and a radius arises. The wiper blade rubber may also be locally broken off at the edges. These phenomena both result in the window wiper losing the wiping force thereof and the window no longer being clear so as to be free from water.

A tool having the features mentioned at the beginning is disclosed by DE 20 2004 019 683. In this case, the blade is arranged in a fixed position in the tool.

Furthermore, it is known from DE 102 43 690, in a similar tool for re-cutting wiper blades, to mount the blade in a cutting unit and to arrange said cutting unit in a height-adjustable manner in the tool such that the level of a cut can be changed. As a result, the tool is suitable for wiper lips of differing height. However, the adjustment mechanism makes the tool considerably more expensive. Furthermore, the handling is made difficult because it is relatively complicated to identify and set the depth of a cut matching the wiper lip.

Taking this as the starting point, the present invention is based on the object of improving the known cutting tool to the effect that said cutting tool is usable for wiper blades of differing profile geometry, in particular differing height. The tool according to the invention is intended to be distinguished by advantageous production costs and unproblematic operability.

### SUMMARY

This object is achieved according to the invention on the basis of the tool known from DE 20 2004 019 683 in that the tool has at least two guide slots, and in that the distance between the guide strips thereof and the associated blade differs.

The invention is based on the finding that many wiper blades have a different profile and may be re-cut not only once but repeatedly. This is possible by means of the tool according to the invention because this tool provides a plurality of guide slots with differing working depths or heights of cut.

In addition, the invention is based on the finding that different wiper blades are on the market and therefore also different tools are required for the re-cutting. The combination according to the invention of a plurality of guide slots in one and the same tool affords the advantage that wiper blades of differing geometry can be treated with the same tool without the user being obliged to carry out adjustment work to the tool.

In order to realize the solution according to the invention, it would in principle be possible to provide a dedicated blade at the desired height of cut for each guide slot. However, it is significantly more advantageous in terms of manufacturing if, according to a development of the invention, a common blade is provided for a plurality of guide slots. This blade can run in a stepped manner with respect to the level of the guide slots or with a slope transversely with respect to the guide slots in order thereby to reach the different depths of cut. Instead, however, it is also possible to arrange the guide strips of the respective guide slots at a differing height with respect to the blade position.

Expediently, a plurality of guide slots are arranged adjacent to one another in the tool, specifically in each case with the guide strips thereof above the blade. Alternatively or additionally, however, further guide slots can be arranged with guide strips below the blade, i.e. on the opposite side of the tool.

As in the known case, the blade is arranged exchangeably in the tool. However, it is particularly expedient if the blade is furthermore also adjustable and lockable in the longitudinal direction. As a result, unused blade regions can be pushed after a certain period of use into the guide slots. This considerably extends the service life of the blade because a large part of the blade extends in the inactive region between two guide slots whereas only a fairly small blade region is effective in the guide slot itself.

For this purpose, the blade or the blades can be mounted on a common carrier which is mounted approximately transversely with respect to the guide slots in the tool and is held in different positions in the tool by latching or snap-in connections.

In a particularly expedient development of the invention, the at least one blade is arranged with a slope relative to the longitudinal direction of the guide slots in such a manner that the cutting edge thereof projects into the guide slot higher than the blade back. As a result, the freshly cut lower border of the wiper blade no longer rubs along the blade and the drawing of the wiper blade through the tool is facilitated.

For the same purpose, it is recommended that the guide slots at least behind the blade or the blades have a significantly greater depth than corresponds to the untrimmed wiper blade because, as a result, the removal of the sliced-off worn border below the blade is facilitated. In particular, the guide slots can be open at the lower end thereof behind the blade or the blades.

So that the user does not have to decide by trial and error which of the various guide slots fits the wiper blade to be re-cut, in an expedient development of the invention the guide slots have a marking which is readily identifiable from the outside and which indicates the associated blade level, i.e. the depth of a cut. As a result, the blade can be positioned more or less invisibly in the central region of the guide slot, i.e. after a certain insertion length of the wiper blade, and the user, when selecting the appropriate guide slot, needs only be oriented by way of the marking—expediently a horizontal line at the level of the cut.

### BRIEF DESCRIPTION OF THE DRAWINGS

Further features and advantages of the invention emerge from the dependent claims and from the description of an exemplary embodiment and from the drawing, in which:

FIG. 1 shows a schematic perspective view of the tool;

FIG. 2 shows a section through the tool along a guide slot with the wiper blade pushed in; and

FIG. 3 shows the blade removed from the tool together with the holder of the blade, as seen from above.

### DETAILED DESCRIPTION OF THE PREFERRED EMBODIMENTS

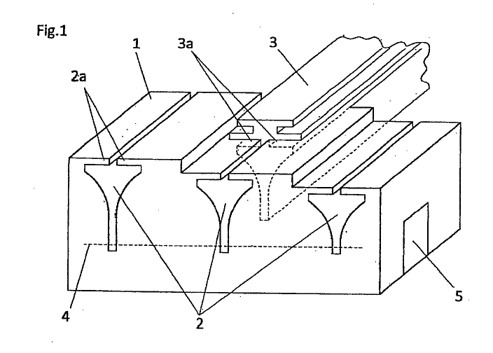

As is seen in particular from the perspective view according to FIG. 1, the tool is comprised of a basic body 1 which has three upwardly open guide slots 2 arranged next to one another. In the exemplary embodiment, the basic body 1 is in the form of a brick-shaped block, but, instead, any other shape is also suitable. As in the known case, the three guide slots 2 each have, at the upper end thereof, two converging guide strips 2a, below which the slot widens. Overall, the contour of the guide slot approximately corresponds to the central and lower region of a wiper blade, as is clear from the wiper blade 3 inserted in the central guide slot 2.

In the vicinity of the lower end of the guide slots 2, the latter are traversed by a common blade 4 which passes therethrough horizontally and is symbolized in FIG. 1 by a dashed line, but is actually arranged within the tool, as FIG. 2 shows. A razor blade is preferably used as the blade.

It is essential that the guide slots, in particular the guide strips 2a thereof, which correspond to corresponding longitudinal grooves 3a of the wiper blade 3, are spaced apart at different distances from the blade 4. This is clear by means of the stepped upper side of the tool 1, which ensures that the left guide slot extends at the highest level, the central guide slot extends at a lower position and the right guide slot extends at the lowermost level. The left guide slot is therefore suitable, for example, for a taller wiper blade which is re-cut for the first time whereas the central or right guide slot is suitable for a shorter wiper blade or a wiper blade which has already been re-cut repeatedly.

FIG. 2 shows the actual cutting operation. In this case, the left end of a wiper blade 3 has been pushed from the right into a matching guide slot 2, i.e. into a guide slot in which the level of the blade 4 is higher than the worn lower border of the wiper blade. The wiper blade is guided in the longitudinal direction by the guide strips 2a which engage on both sides in corresponding wiper blade grooves 3a. By means of the guide slot shape which is matched to the wiper blade contour, it is ensured that the lower region of the wiper blade also has a certain guidance and cannot deviate in the transverse direction, specifically especially wherever the re-cutting takes place. As is seen, the lower border 6 of the wiper blade is sliced off by the blade 4.

The cutting off and slicing off of the worn lower border 6 are assisted by the fact that the blade 4 is installed in the tool 1 with a slope in relation to the push-through direction of the wiper blade such that the cutting edge of said blade is higher, i.e. protrudes further into the guide slot, than the blade back.

As FIG. 2 also shows, the blade 4 traversing all of the guide slots is fitted on a carrier 5, especially preferably via elongated holes, so that said blade is adjustable in the longitudinal direction. The blade carrier 5 traverses the tool 1 and is able to be drawn out together with the blade at least on the one side of the tool. The blade carrier 5 can be locked in the tool 1 by means of a latching connection or screws, etc. Instead, however, the blade carrier itself may also be arranged in the tool so as to be adjustable and lockable transversely with respect to the longitudinal slots.

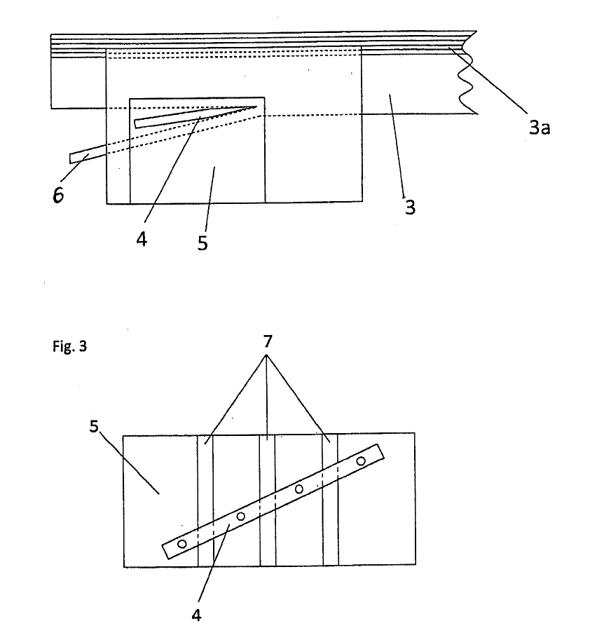

FIG. 3 shows the blade carrier 5, in particular the formation thereof in the lower region of the guide slots 2. It is seen that the blade carrier has a recess 7 there in each case below the blade 4. This recess is necessary so that the sliced-off lower border 6 can pass the blade carrier 5 and can be pushed through the guide slot 2 together with the wiper blade 3. The recess 7 can run vertically through the entire tool 1, i.e. can be open at the bottom. The width of said recess can be larger than illustrated in FIG. 3 if the blade carrier 5 is arranged in the tool 1 so as to be adjustable transversely with respect to the guide slots, i.e. if unused regions of the blade 4 are to be pushed into the guide slots.

Finally, FIG. 3 shows that the blade 4 does not run precisely perpendicularly to the guide slots, but rather obliquely at an angle of approximately 30°. This assists the cutting operation.

1. A tool for re-cutting abraded wiper blades (3) for window wipers, wherein the wiper blades (3) have an increasing cross section from the border thereof on the window side and at least one longitudinal groove (3a) on both sides therein, the tool comprising a guide slot (2) with at least one guide strip (2a) that corresponds to said longitudinal grooves (3a) in such a manner that the wiper blade (3) is drawable in a longitudinal direction through the guide slot (2) at a defined height, a blade (4) which is adapted slice off a worn border (6) of the wiper blade (3) as the wiper blade is drawn through the tool is arranged in the guide slot (2), at least two of the guide slots (2) are located in the tool in which a distance between the guide strips (2a) thereof and the blade(s) (4) for the respective guide slot differs and the different distance between the guide strips (2a) and the associated blade or blades (4) is present without adjustment work on the tool.

2. The tool as claimed in claim 1, wherein a common blade (4) is provided for a plurality of the guide slots (2).

3. The tool as claimed in claim 1, wherein the guide strips (2a) are arranged at differing height with respect to a level of the blade (4).

4. The tool as claimed in claim 1, wherein a plurality of the guide slots (2) are arranged next to one another.

5. The tool as claimed in claim 1, wherein the guide slots (2) are arranged at least one of below or above the at least one blade (4).

6. The tool as claimed in claim 1, wherein the at least one blade (4) is mounted adjustably in the longitudinal direction thereof and is lockable in different longitudinal positions in the tool.

7. The tool as claimed in claim 1, wherein the blade (4) is formed by a razor blade.

8. The tool as claimed in claim 1, wherein the at least one blade (4) is mounted on a blade carrier (5) which is removable together with the blade or the blades (4) from the tool (1).

9. The tool as claimed in claim 8, wherein the blade carrier (5) is mounted in the tool in a sliding guide approximately transversely with respect to the guide slots (2).

10. The tool as claimed in claim 8, wherein the blade carrier (5) is held in the tool (1) by a latching or snap-in connection.

11. The tool as claimed in claim 1, wherein the at least one blade (4) is arranged with a slope relative to the longitudinal direction of the guide slots (2) in such a manner that a cutting edge thereof projects into the guide slot (2) higher than a blade back.

12. The tool as claimed in claim 1, wherein the guide slots (2) at least behind the blade or the blades (4) have a greater depth than corresponds to the wiper blade.

13. The tool as claimed in claim 1, wherein a marking which indicates a depth of the cut belonging to a particular one of the guide slots (2) is arranged at one end of the guide slots (2).
